(19) United States
(12) Patent Application Publication
(10) Pub. No.: US 2014/0069540 A1
(43) Pub. Date: Mar. 13, 2014

(54) WRAPPABLE SLEEVE WITH HEATING ELEMENTS AND METHODS OF USE AND CONSTRUCTION THEREOF

(71) Applicants: Jean Renee Chesnais, Crepy en Valois (FR); Isabelle Fradin, Clermont (FR); Patrick Thomas, Crepy en Valois (FR)

(72) Inventors: Jean Renee Chesnais, Crepy en Valois (FR); Isabelle Fradin, Clermont (FR); Patrick Thomas, Crepy en Valois (FR)

(21) Appl. No.: 13/610,424

(22) Filed: Sep. 11, 2012

(51) Int. Cl. F16L 53/00

(52) U.S. Cl. 138/32

(57) ABSTRACT

A wrappable protective sleeve for preventing fluid from freezing in a conduit; method of protecting and heating a conduit, and method of constructing a sleeve for protecting and heating a conduit are provided. The sleeve includes an elongate wall having opposite edges extending lengthwise between opposite ends. The opposite edges are configured to overlap one another to form a dual layer overlap region including an outer portion and an inner portion underlying the outer portion to provide an enclosed tubular cavity. The at least one elongate heating element extends between the opposite ends within the inner portion of said wall.

### BACKGROUND OF THE INVENTION

1. Technical Field

This invention relates generally to protective sleeves, and more particularly to wrappable protective sleeves having heating elements.

2. Related Art

Many vehicle applications include tubes, also referred to as conduits, to direct the flow of fluids, such as selective catalytic reduction (SCR) applications, for example. When the fluid is intended to flow through the conduit, it is necessary to prevent the fluid from freezing. For example, SCR applications, particularly in diesel engine applications which run cooler than gasoline engines, can incorporate conduits for injecting ammonia or urea solutions into the exhaust pipe upstream of a catalytic converter. The injected solution evaporates and mixes with the exhaust gases to create a chemical reaction that will reduce NOx, and instead produce nitrogen and water. However, in order for the ammonia or urea solution to remain useful, it must remain fluid (liquid) within the conduit and thus, it must be kept from freezing.

### SUMMARY OF THE INVENTION

In accordance with one aspect of the invention, a wrappable protective sleeve is provided that can be readily wrapped about a fluid conduit to prevent fluid flowing through the conduit from freezing. The sleeve includes an elongate wall having opposite edges extending lengthwise between opposite ends. The opposite edges are configured to overlap one another to form a dual layer overlap region including an outer portion and an inner portion underlying the outer portion to provide an enclosed tubular cavity. The at least one elongate heating element extends between the opposite ends within the inner portion of said wall.

In accordance with another aspect of the invention, the at least one heating element is interlaced within the dual layer overlap region of the wall. As such, the at least one heating element is protected by the overlying portion of the wall from exposure to the surrounding environment.

In accordance with another aspect of the invention, the wall has an inner surface facing the inner tubular cavity and an outer surface facing away from the inner tubular cavity. The at least one heating element is exposed to the inner tubular cavity from the inner surface to readily expose the conduit to heat generated by the heating element.

In accordance with another aspect of the invention, the at least one heating element is substantially concealed from exposure to the surrounding environment by the outer surface to provide protection against damage to the heating element.

In accordance with another aspect of the invention, one of the opposite edges of the wall forms an inner edge exposed to the cavity wherein the at least one heating element is interlaced to the wall immediately adjacent the inner edge.

In accordance with another aspect of the invention, the wall is readily twistable to bring the at least one heating element into a helical configuration about the cavity. As such, the heating element is able to be disposed about the entire or substantially entire outer circumference of the conduit to facilitate heating the fluid flowing therethrough.

In accordance with another aspect of the invention, the at least one heating element is coextruded in material of the wall to provide protection against damage to the heating element.

In accordance with another aspect of the invention, the at least one heating element extends between opposite ends of the sleeve in a non-straight, curvilinear fashion.

In accordance with another aspect of the invention, the at least one heating element extends between opposite ends of the sleeve in a non-straight, curvilinear fashion adjacent a longitudinally extending edge of the sleeve.

In accordance with another aspect of the invention, a method of protecting and heating a conduit is provided. The method includes providing an elongate wall having opposite inner and outer edges extending lengthwise between opposite ends with at least one elongate heating element extending between the opposite ends. Further, wrapping the wall about the conduit and overlapping the opposite inner and outer edges to form a dual layer overlap region including an outer portion and an inner portion underlying the outer portion. Further yet, the method includes operably connecting the at least one heating element to a power source sufficient to heat the at least one heating element.

In accordance with another aspect of the invention, the method of protecting and heating a conduit further includes providing the elongate wall having at least one interlaced yarn with the at least one heating element fixed to the inner portion with the at least one interlaced yarn.

In accordance with another aspect of the invention, the method of protecting and heating a conduit further includes providing the at least one heating element being fixed to the wall with a plurality of circumferentially extending yarns.

In accordance with another aspect of the invention, the method of protecting and heating a conduit further includes providing the at least one heating element with floats extending between each of the plurality of circumferentially extending yarns.

In accordance with another aspect of the invention, the method of protecting and heating a conduit further includes providing the at least one heating element being exposed to an inner cavity of the sleeve and being substantially shielded by an outer surface of the wall.

In accordance with another aspect of the invention, the method of protecting and heating a conduit further includes providing the wall as a self-wrapping, tubular wall.

In accordance with another aspect of the invention, the method of protecting and heating a conduit further includes providing the wall as a sheet of impervious material.

In accordance with another aspect of the invention, the method of protecting and heating a conduit further includes providing the at least one heating element being co-extruded with the sheet of impervious material.

In accordance with another aspect of the invention, a method of constructing a sleeve for protecting and heating a conduit is provided. The method includes constructing an elongate wall having opposite inner and outer edges extending lengthwise between opposite ends. Further, fixing at least one elongate heating element to the wall with the at least one heating element extending between the opposite ends and configuring the at least one elongate heating element for operable connection to a power source. Then, the method includes configuring the elongate wall to wrap about the conduit with the opposite inner and outer edges overlapping one another to form a dual layer overlap region with the at least one elongate heating element extending within the dual layer overlap region.

In accordance with another aspect of the invention, the method of constructing a sleeve for protecting and heating a conduit further includes constructing the elongate wall from at least one interlaced yarn and fixing the at least one heating element to the inner portion with the at least one interlaced yarn while constructing the wall.

In accordance with another aspect of the invention, the method of constructing a sleeve for protecting and heating a conduit further includes interlacing the at least one heating element to the inner portion adjacent the inner edge.

In accordance with another aspect of the invention, the method of constructing a sleeve for protecting and heating a conduit further includes forming the wall by interlacing a plurality of yarns with one another and fixing the at least one heating element to the wall with a plurality of circumferentially extending yarns.

In accordance with another aspect of the invention, the method of constructing a sleeve for protecting and heating a conduit further includes configuring the at least one heating element having floats extending between each of the plurality of circumferentially extending yarns.

In accordance with another aspect of the invention, the method of constructing a sleeve for protecting and heating a conduit further includes exposing the at least one heating element to an inner cavity of the sleeve and substantially shielding the at least one heating element with an outer surface of the wall.

In accordance with another aspect of the invention, the method of constructing a sleeve for protecting and heating a conduit further includes constructing the wall as a textile fabric.

In accordance with another aspect of the invention, the method of constructing a sleeve for protecting and heating a conduit further includes heat-setting the wall into a self-wrapping, tubular configuration.

In accordance with another aspect of the invention, the method of constructing a sleeve for protecting and heating a conduit further includes constructing the wall as a sheet of impervious material.

In accordance with another aspect of the invention, the method of constructing a sleeve for protecting and heating a conduit further includes co-extruding the at least one heating element with the sheet of impervious material.

### BRIEF DESCRIPTION OF THE DRAWINGS

These and other aspects, features and advantages of the present invention will become more readily appreciated when considered in connection with the following detailed description of presently preferred embodiments and best mode, appended claims and accompanying drawings, in which:

FIG. 1 is a schematic perspective view of a heated, wrappable textile sleeve constructed in accordance with one aspect of the invention shown wrapped completely about a fluid conduit;

FIG. 2 is a schematic end view of the sleeve of FIG. 1;

FIG. 3 is schematic plan view of the sleeve of FIG. 1, as woven, shown in an unwrapped, flat configuration;

FIG. 3A is a view similar to FIG. 3 illustrating an embodiment of a heated, wrappable textile sleeve constructed in accordance with another aspect of the invention;

FIG. 4 is schematic plan view of the sleeve of FIG. 1, as knit, shown in an unwrapped configuration;

FIG. 5 is schematic plan view of the sleeve of FIG. 1, as braided, shown in an unwrapped configuration;

FIG. 5A is a view similar to FIG. 5 illustrating an embodiment in accordance with another aspect of the invention;

FIG. 6 is a schematic perspective view of a sleeve constructed in accordance with another aspect of the invention shown wrapped helically about the fluid conduit;

FIG. 7 is a schematic perspective view of a sleeve constructed in accordance with another aspect of the invention; and

FIG. 8 is a partial schematic perspective view of the sleeve of FIG. 7 shown in an unwrapped configuration.

### DETAILED DESCRIPTION OF PRESENTLY PREFERRED EMBODIMENTS

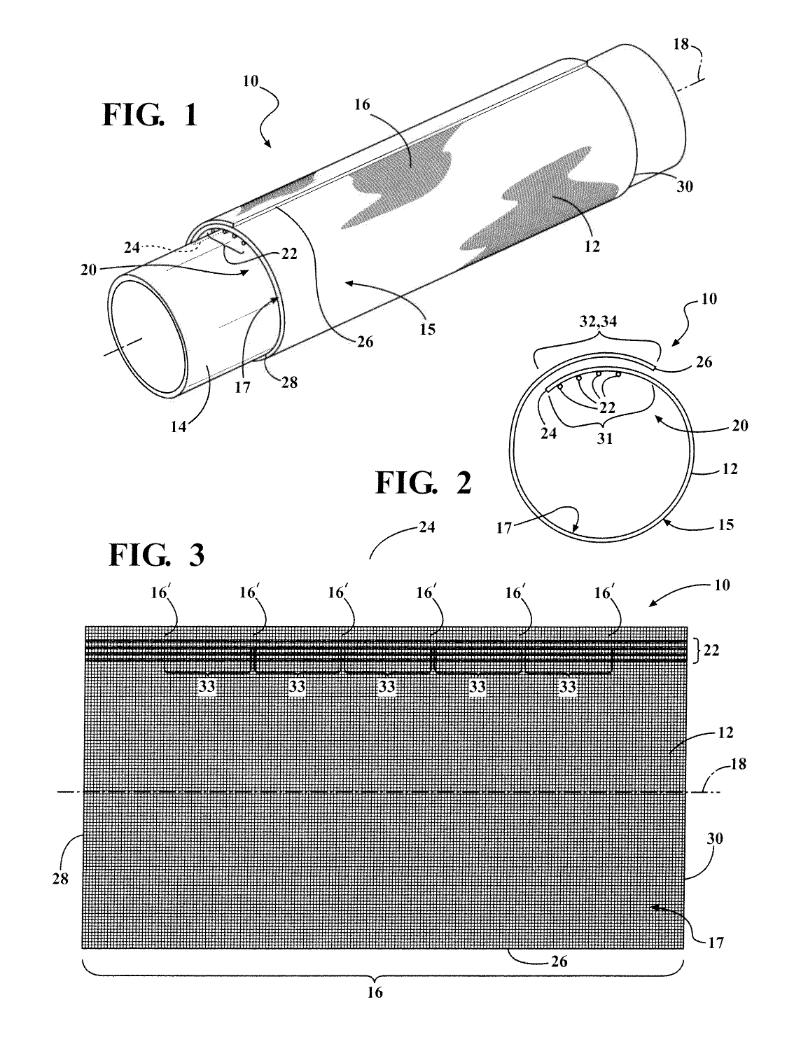

Referring in more detail to the drawings, FIG. 1 illustrates a wrappable protective sleeve, referred to hereafter as sleeve 10, constructed in accordance with one aspect of the invention. The sleeve 10 is preferably constructed having a self-wrapping elongate wall 12 for protecting a pipe, also referred to as fluid conduit 14, such as a conduit for conveying ammonia or urea solution in a SCR system, from direct exposure to abrasion, thermal and other environmental conditions. The elongate wall 12 has an outer surface 15 and an inner surface 17, with the wall 12 being constructed from at least one interlaced yarn 16 or a plurality of interlaced yarns 16. Provided the wall 12 is constructed as a self-wrapping wall, at least one of the yarns 16 is provided as a heat-settable yarn such that upon being heat-set, the inner surface 17 is brought into a self-wrapping tubular configuration to provide an enclosed tubular inner cavity 20 when in its relaxed, self-wrapped configuration. The cavity 20 is readily accessible along a longitudinal axis 18 of the sleeve 10 so that the sleeve 10 can be readily disposed about the conduit 14, and conversely, removed from the conduit 14, such as during service. To prevent fluid within the conduit 14 from freezing, at least one elongate heating element 22 is interlaced in the wall 12 and the heating element 22 is configured to be operably coupled to an energy source, such as at free ends of the heating element 22, to generate sufficient resistive heat within the heating element 22 to prevent the fluid within the fluid conduit 14 from freezing.

The wall 12 can be constructed having any suitable size, including length, diameter and wall thickness. The wall 12 has opposite inner and outer edges 24, 26 extending along the axis 18 in parallel or substantially parallel relation with the axis 18 between open opposite ends 28, 30 of the sleeve 10. When the wall 12 is in its self-wrapped tubular configuration, generally free from any externally applied forces, the edges 24, 26 and corresponding surfaces of the wall 12 adjacent the opposite edges 24, 26 are brought into overlapping relation with one another to form a dual layer overlap region 32 (FIG. 2) including a shielded underlying inner portion 31 and an overlying outer portion 34 to fully enclose the cavity 20 about its circumference. The edges 24, 26 are readily extendable away from one another under an externally applied force to at least partially open and expose the cavity 20, whereupon the edges 24, 26 return automatically to their natural, overlapping self-wrapped position upon releasing the externally applied force.

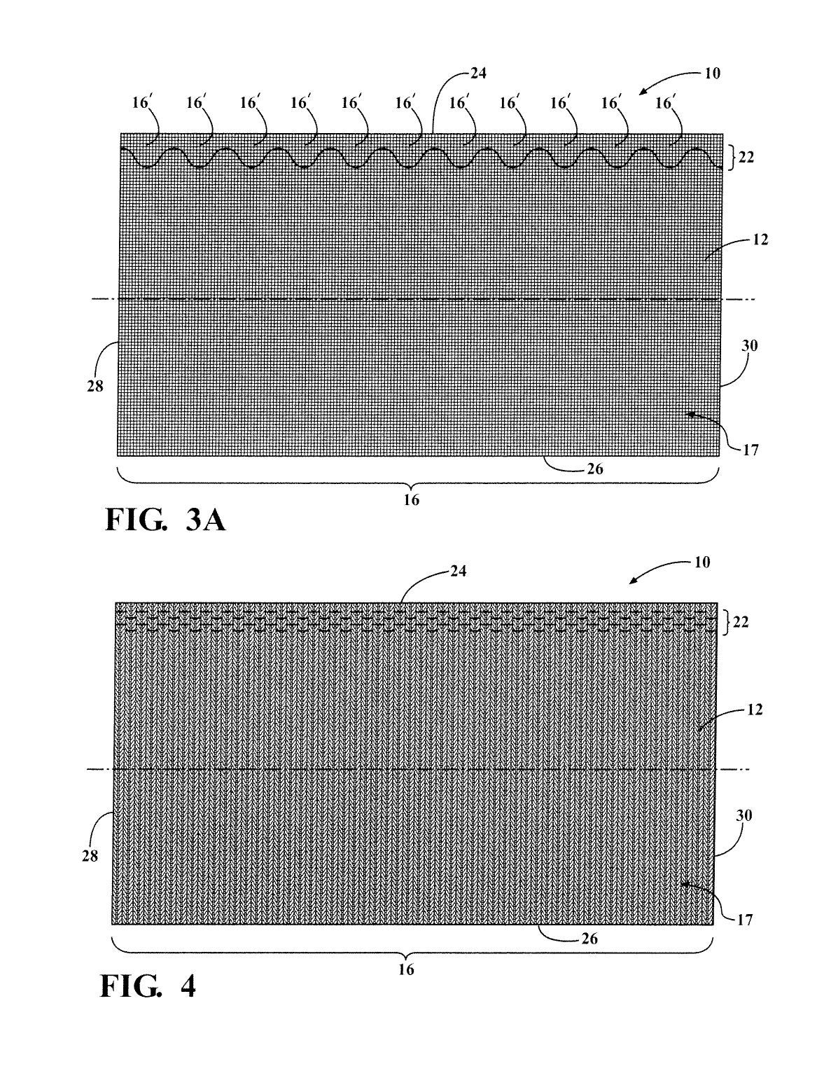

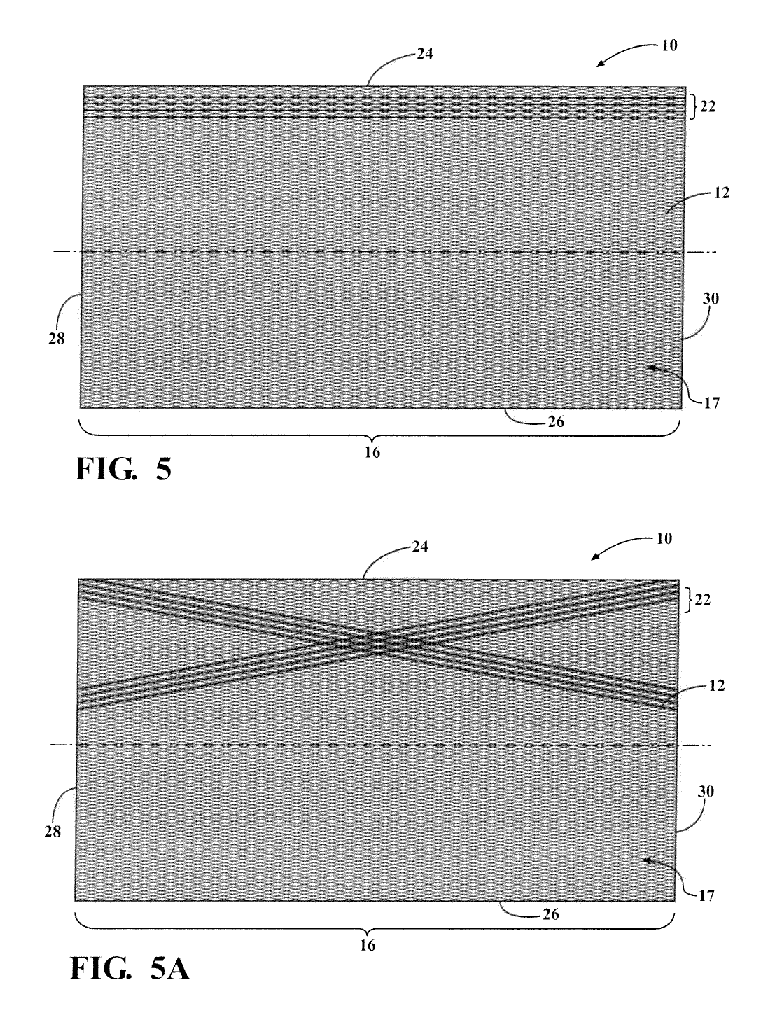

The wall 12 can be constructed as a textile wall including interlaced yarns 16. The yarns 16 can be provided as multifilament and/or monofilament yarns, as long as one or more of the circumferentially extending yarns is heat-settable to allow the wall 12 to be heat-set to take on the self-wrapping configuration discussed above. The wall 12 can be woven (FIGS. 3 and 3A), knit, such as via a weft knit (FIG. 4), or braided (FIGS. 5 and 5A), with the yarns 16, as desired. In addition, the wall 12 can be provided as a non-woven wall, if desired for the intended application.

The at least one heating element, shown in FIGS. 1-3, by way of example and without limitation, as being a plurality of heating elements 22, can be provided of any suitable insulated or non-insulated resistive wire. Further, the resistivity of the heating elements 22 can be selected as desired to generate the increased temperature needed for the intended application, taking into account various factors, such as the geometry of the sleeve wall 12, the geometry of the conduit 14 and the heat required in the intended application to prevent the fluid from freezing within the conduit 14. As such, the heating elements 22 can be provide as round wire, flattened wire, conductive fibers, or otherwise.

The heating elements 22 are interlaced in the wall 12, such as by circumferentially extending yarns 16′, to form lengthwise extending floats 33 of the heating elements 22 that are openly exposed to the inner tubular cavity 20. As such, the floats 33 are freely exposed inwardly of the inner surface 17 to directly impinge the conduit 14 with heat generated by the heating elements 22. Although being exposed inwardly of the inner surface 17, the heating elements 22 are concealed or substantially concealed, by the outer surface 15 of the wall 12, from exposure to the outer surrounding environment. Further, the heating elements 22 are shown as being interlaced for containment within the inner portion 31 of the dual layer overlap region 32 of the wall 12. The inner edge 24 of the wall 12 forms a radially innermost edge 24 exposed to the cavity 18, wherein the heating elements 22 are interlaced to the wall 12 adjacent the inner edge 24. For example, in FIG. 3, by way of example and without limitation, the heating elements 22 are shown as extending parallel or substantially parallel to the axis 18. However, it should be recognized, as shown in FIG. 3A, that one or more of the heating elements 22 can extend between the opposite ends 28, 30 in a non-straight, curvilinear configuration, such as in a generally sinusoidal configuration, for example. Accordingly, by meandering along a non-straight path, fewer heating elements, shown as a single heating element 22, can be used to heat a predetermined circumferentially extending arc of the sleeve 10, if desired. Further yet, the heating elements 22 could extend about, or partially about the wall 12 in a helical fashion, particularly if integrated into a braided wall 12 (FIG. 5A). However, the heating elements 22 could also extend straight in a braided wall 12 if incorporated as a warp inserted member (FIG. 5). Regardless, the heating elements 22 can be maintained within the protected underlying, inner portion 31 of the wall 12 such that they are sufficiently protected from exposure to external elements, e.g. thermal, debris, water, contamination, of the surrounding environment by both the overlying outer surface 15 of the wall 12 inner portion 31 as well as the overlying outer portion 34 of the wall 12. With the heating elements 22 being confined to the inner portion 31 of the wall 12 and the remaining portion of the wall, including the outer portion 34, remaining free of the heating elements 22, the heating elements 22 are assured of being optimally protected against the possibility of damage, thereby extending the useful life of the sleeve 10. To expose an end or ends of the heating elements 22 for attachment to the energy source (not shown), one or more of the circumferentially extending yarns overlying the heating elements 22 adjacent the ends 28, 30 can be readily cut, as desired.

To facilitate maintaining the wall 12 of the sleeve 10 in its wrapped configuration about the conduit 14, any variety of closure mechanisms can be incorporated into the wall 12. For example, adhesives including pressure sensitive adhesives, hook and loop type fasteners, snaps or other mechanical fastening mechanisms could be integrally applied or attached adjacent one or both edges 24, 26.

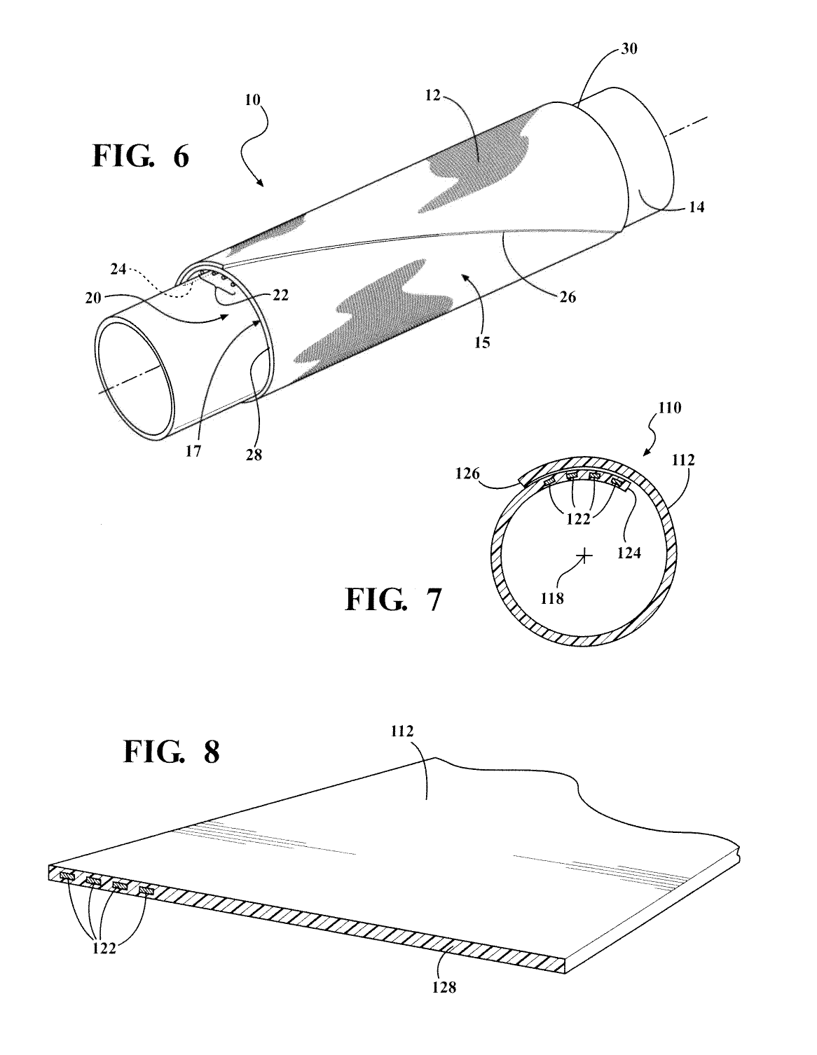

In accordance with another aspect of the invention, rather than wrapping the wall 12 with the edges 24, 26 extending parallel or substantially parallel to the axis 18, the wall 12 can be readily twisted helically to bring the at least one heating element 22 into a helical configuration about the conduit 14, as shown in FIG. 6. As such, the heating elements 22 are able to be disposed circumferentially about the entire circumference of the conduit 14 to facilitate heating the fluid flowing therethrough.

In FIGS. 7 and 8, a sleeve 110 constructed in accordance with another aspect of the invention is shown, wherein the same reference numerals, offset by a factor of 100, are used to identify like features. The sleeve 110 has a wall 112 that is formed as a sheet of material, rather than being constructed as a textile fabric, such as via a weaving, knitting, braiding, or nonwoven process, as discussed above. The wall 112, as discussed above, has opposite edges 124, 126 extending along and parallel or substantially parallel to a longitudinal central axis 118 between opposite ends 128, 130 (not shown). The wall 112, being provided as a sheet of material, can be formed from any suitable plastic material in an extrusion process, laminating process, molding process, or otherwise. In the example illustrated, the wall 112 is formed in a co-extrusion process as an impervious wall wherein heating elements 122 are co-extruded within the material of the wall 112. Accordingly, the heating elements 122 can be encapsulated along their length, at least partially or entirely, and thus, are protected against damage by the surrounding material of the wall 122. It should be recognized that if a laminating process is used to construct the wall 112 that the heating elements 122 can be sandwiched between joined layers, thereby providing protection to the heating elements 122. Of course, ends or intermediate portions of the heating elements 122 can be made accessible, as desired, for operable connection to an energy source. The heating elements 122 can be configured in any of the configurations discussed above and illustrated, including extending in straight or curvilinear fashion between the opposite ends 128, 130.

Many modifications and variations of the present invention are possible in light of the above teachings. It is, therefore, to be understood that the invention may be practiced otherwise than as specifically described, and that the scope of the invention is defined by any ultimately allowed claims.

What is claimed is:

1. A wrappable sleeve for preventing fluid from freezing in a conduit about which the sleeve is wrapped, comprising:
an elongate wall having opposite edges extending lengthwise between opposite ends, said opposite edges being configured to overlap one another to form a dual layer overlap region including an outer portion and an inner portion underlying said outer portion to provide an enclosed tubular cavity; and
at least one elongate heating element extending between said opposite ends within said inner portion of said wall.

2. The wrappable sleeve of claim 1 wherein said elongate wall is constructed from at least one interlaced yarn and said at least one heating element is fixed to said inner portion by said at least one interlaced yarn.

3. The wrappable sleeve of claim 2 wherein one of said opposite edges forms an inner edge exposed to said cavity, said at least one heating element being interlaced to said inner portion adjacent said inner edge.

4. The wrappable sleeve of claim 2 wherein said at least one yarn includes a plurality of yarns and said heating element is fixed to said wall by a plurality of circumferentially extending yarns.

5. The wrappable sleeve of claim 4 wherein said at least one heating element has floats extending between said plurality of circumferentially extending yarns.

6. The wrappable sleeve of claim 1 wherein said wall has an inner surface facing said tubular cavity and an outer surface facing away from said tubular cavity, said at least one heating element being exposed to said cavity from said inner surface and being substantially shielded by said outer surface.

7. The wrappable sleeve of claim 1 wherein said wall is twistable to bring said at least one heating element into a helical configuration about said cavity.

8. The wrappable sleeve of claim 1 wherein said wall is a textile fabric.

9. The wrappable sleeve of claim 8 wherein said wall is heat-set into a self-wrapping, tubular configuration.

10. The wrappable sleeve of claim 1 wherein said wall is a sheet of impervious material.

11. The wrappable sleeve of claim 10 wherein said at least one heating element is co-extruded within said sheet of impervious material.

10. A method of protecting and heating a conduit, comprising:
providing an elongate wall having opposite inner and outer edges extending lengthwise between opposite ends with at least one elongate heating element extending between the opposite ends;
wrapping the wall about the conduit and overlapping the opposite inner and outer edges to form a dual layer overlap region including an outer portion and an inner portion underlying the outer portion; and
operably connecting the at least one heating element to a power source sufficient to heat the at least one heating element.

11. The method of claim 10 further including providing the elongate wall having at least one interlaced yarn with the at least one heating element fixed to the inner portion with the at least one interlaced yarn.

12. The method of claim 11 further including providing the at least one heating element being fixed to the wall with a plurality of circumferentially extending yarns.

14. The method of claim 13 further including providing the at least one heating element with floats extending between each of the plurality of circumferentially extending yarns.

15. The method of claim 10 further including providing the at least one heating element being exposed to an inner cavity of the sleeve and being substantially shielded by an outer surface of the wall.

17. The method of claim 10 further including providing the wall as a self-wrapping, tubular wall.

18. The method of claim 10 further including providing the wall as a sheet of impervious material.

19. The method of claim 18 further including providing the at least one heating element being co-extruded with the sheet of impervious material.

20. A method of constructing a sleeve for protecting and heating a conduit, comprising:
constructing an elongate wall having opposite inner and outer edges extending lengthwise between opposite ends;
fixing at least one elongate heating element to the wall with the at least one heating element extending between the opposite ends;
configuring the at least one elongate heating element for operable connection to a power source;
configuring the elongate wall to wrap about the conduit with the opposite inner and outer edges overlapping one another to form a dual layer overlap region with the at least one elongate heating element extending within the dual layer overlap region.

21. The method of claim 20 further including constructing the elongate wall from at least one interlaced yarn and fixing the at least one heating element to the inner portion with the at least one interlaced yarn while constructing the wall.

22. The method of claim 21 further including interlacing the at least one heating element to the inner portion adjacent the inner edge.

23. The method of claim 21 further including forming the wall by interlacing a plurality of yarns with one another and fixing the at least one heating element to the wall with a plurality of circumferentially extending yarns.

24. The method of claim 23 further including configuring the at least one heating element having floats extending between each of the plurality of circumferentially extending yarns.

25. The method of claim 20 further including exposing the at least one heating element to an inner cavity of the sleeve and substantially shielding the at least one heating element with an outer surface of the wall.

26. The method of claim 20 further including constructing the wall as a textile fabric.

27. The method of claim 26 further including heat-setting the wall into a self-wrapping, tubular configuration.

28. The method of claim 20 further including constructing the wall as a sheet of impervious material.

29. The method of claim 28 further including co-extruding the at least one heating element with the sheet of impervious material.
